(19) United States
(12) Patent Application Publication
(10) Pub. No.: US 2026/0292587 A1
(43) Pub. Date: Sep. 24, 2026

(54) APPARATUS, METHOD, AND COMPUTER PROGRAM

(71) Applicant: Nokia Technologies Oy, Espoo (FI)

(72) Inventors: Bighnaraj PANIGRAHI, Bangalore (IN); Saubhagya BALIARSINGH, Bangalore (IN); Jisha GEORGE, Bangalore (IN); Deepa MALAPATI RAVINDRAIAH, Bangalore (IN); Devaki CHANDRAMOULI, Dallas, TX (US)

(21) Appl. No.: 19/472,464

(22) PCT Filed: Apr. 5, 2024
(86) PCT No.: PCT/EP2024/059314

§ 371 Date: Oct. 3, 2025

(30) Foreign Application Priority Data
Apr. 6, 2023 (IN) 202311026029

(51) Int. Cl. H04W 28/02; H04L 47/31

(52) U.S. Cl. CPC H04W 28/0289; H04L 47/31

(57) ABSTRACT

There is provided a computer program, method, and apparatus for performing: receiving an indication that a user equipment will be or has been handed over from a first access network node to a second access network node, the first access network node being configured to provide a first congestion control mechanism; receiving an indication that the second access network node does not support the first congestion control mechanism; determining that a user plane function is able to perform a second congestion control mechanism; and signalling the user plane function a request to perform the second congestion control mechanism for at least one packet signalled between the user equipment and the second access network node.

### TECHNICAL FIELD

The examples described herein generally relate to apparatus, methods, and computer programs, and more particularly (but not exclusively) to apparatus, methods and computer programs for apparatus.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards, such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined therein. Examples include the so-called 5G standards.

### SUMMARY

According to a first example, there is provided an apparatus comprising means for: receiving an indication that a user equipment will be or has been handed over from a first access network node to a second access network node, the first access network node being configured to provide a first congestion control mechanism; receiving an indication that the second access network node does not support the first congestion control mechanism; determining that a user plane function is able to perform a second congestion control mechanism; and signalling the user plane function a request to perform the second congestion control mechanism for at least one packet signalled between the user equipment and the second access network node.

The apparatus may comprise means for signalling an instruction to the second access network node to provide congestion information on said at least one packet to the user plane function that indicates whether the at least one packet experienced congestion.

The determining that the user plane function is able to perform the second congestion control mechanism may comprise receiving an indication from the user plane function that the user plane function is able to perform the second congestion control mechanism.

The first and second congestion control mechanisms may both comprise marking the at least one packet as congested.

The apparatus may comprise means for determining that a user plane function is unable to perform a second congestion control mechanism.

The first and second congestion control mechanisms may both comprise marking the at least one packet as congested.

The apparatus may comprise means for performing functions of a session management function.

The apparatus may comprise means for implementing a virtual network function instance of the session management function.

The apparatus may comprise means for maintaining session information for a session between an application function or application server and the user equipment via either the first or second access network node.

The indication that the second access network node does not support the first congestion control mechanism may be received from the second access network node.

The indication that the second access network node does not support the first congestion control mechanism may be received via a session update request.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a second example, there is provided an apparatus comprising means for: receiving an indication that a user equipment will be or has been handed over from a first access network node to a second access network node, the first access network node being configured to provide a first congestion control mechanism; receiving an indication that the second access network node does not support the first congestion control mechanism; determining that a second access network node is able to perform a third congestion control mechanism; and signalling to the second access network node an instruction to perform the third congestion control mechanism for at least one packet signalled between the second access network node and the user equipment.

The apparatus may comprise means for determining that a user plane function is unable to perform a second congestion control mechanism.

The first and second congestion control mechanisms may both comprise marking the at least one packet as congested.

The apparatus may comprise means for performing functions of a session management function.

The apparatus may comprise means for implementing a virtual network function instance of the session management function.

The apparatus may comprise means for maintaining session information for a session between an application function or application server and the user equipment via either the first or second access network node.

The indication that the second access network node does not support the first congestion control mechanism may be received from the second access network node.

The indication that the second access network node does not support the first congestion control mechanism may be received via a session update request.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a third example, there is provided an apparatus comprising means for: determining that a user equipment will be or has been handed over from a first access network node to the apparatus; determining that the apparatus does not support a first congestion control mechanism that is performed by the first access network node; signalling to a core network node an indication that the apparatus does not support the first congestion control mechanism; and receiving, from the core network node, an instruction to provide congestion information to a user plane function for at least one packet signalled between the user equipment and the second access network node.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a fourth example, there is provided an apparatus comprising means for: determining that a user equipment will be or has been handed over from a first access network node to the apparatus; determining that the access network node does not support a first congestion control mechanism that is performed by the first access network node; signalling to a core network apparatus an indication that the apparatus does not support the first congestion control mechanism; and receiving, from the core network apparatus, an instruction to provide congestion information to an application function or application server for at least one packet signalled between the user equipment and the second access network node.

The apparatus may comprise means for explicitly sending the congestion information to the application function or application server either by using user plane or control plane.

The apparatus may comprise means for performing functions of a second access network node.

The apparatus may be implemented as the first access network node.

The indication that the second access network node does not support the first congestion control mechanism may be comprised in a handover request acknowledgement.

The indication that the second access network node does not support the first congestion control mechanism may be comprised in a path switch request.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a fifth example, there is provided an apparatus comprising means for: determining that a user equipment will be or has been handed over from a first cell provided by a first access network node to a second cell provided by a second access network node; and providing, to the second access network node, an indication that the first access network node supports a first congestion control mechanism that is provided by the first access network node.

The apparatus may comprise means for performing functions of the first access network node.

The apparatus may be implemented as the first access network node.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a sixth example, there is provided an apparatus comprising at least one processor; and at least one memory storing instructions (e.g., computer program code) that, when executed by the at least one processor, cause the apparatus at least to perform: receiving an indication that a user equipment will be or has been handed over from a first access network node to a second access network node, the first access network node being configured to provide a first congestion control mechanism; receiving an indication that the second access network node does not support the first congestion control mechanism; determining that a user plane function is able to perform a second congestion control mechanism; and signalling the user plane function a request to perform the second congestion control mechanism for at least one packet signalled between the user equipment and the second access network node.

The apparatus may be caused to perform: signalling an instruction to the second access network node to provide congestion information on said at least one packet to the user plane function that indicates whether the at least one packet experienced congestion.

The determining that the user plane function is able to perform the second congestion control mechanism may comprise receiving an indication from the user plane function that the user plane function is able to perform the second congestion control mechanism.

The first and second congestion control mechanisms may both comprise marking the at least one packet as congested.

The apparatus may be caused to perform: determining that a user plane function is unable to perform a second congestion control mechanism.

The first and second congestion control mechanisms may both comprise marking the at least one packet as congested.

The apparatus may be caused to perform: functions of a session management function.

The apparatus may be caused to perform: implementing a virtual network function instance of the session management function.

The apparatus may be caused to perform: maintaining session information for a session between an application function or application server and the user equipment via either the first or second access network node.

The indication that the second access network node does not support the first congestion control mechanism may be received from the second access network node.

The indication that the second access network node does not support the first congestion control mechanism may be received via a session update request.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a seventh example, there is provided an apparatus comprising at least one processor; and at least one memory storing instructions (e.g., computer program code) that, when executed by the at least one processor, cause the apparatus at least to perform: receiving an indication that a user equipment will be or has been handed over from a first access network node to a second access network node, the first access network node being configured to provide a first congestion control mechanism; receiving an indication that the second access network node does not support the first congestion control mechanism; determining that a second access network node is able to perform a third congestion control mechanism; and signalling to the second access network node an instruction to perform the third congestion control mechanism for at least one packet signalled between the second access network node and the user equipment.

The apparatus may be caused to perform: determining that a user plane function is unable to perform a second congestion control mechanism.

The first and second congestion control mechanisms may both comprise marking the at least one packet as congested.

The apparatus may be caused to perform: functions of a session management function.

The apparatus may be caused to perform: implementing a virtual network function instance of the session management function.

The apparatus may be caused to perform: maintaining session information for a session between an application function or application server and the user equipment via either the first or second access network node.

The indication that the second access network node does not support the first congestion control mechanism may be received from the second access network node.

The indication that the second access network node does not support the first congestion control mechanism may be received via a session update request.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to an eighth example, there is provided an apparatus comprising at least one processor; and at least one memory storing instructions (e.g., computer program code) that, when executed by the at least one processor, cause the apparatus at least to perform: determining that a user equipment will be or has been handed over from a first access network node to the apparatus; determining that the apparatus does not support a first congestion control mechanism that is performed by the first access network node; signalling to a core network node an indication that the apparatus does not support the first congestion control mechanism; and receiving, from the core network node, an instruction to provide congestion information to a user plane function for at least one packet signalled between the user equipment and the second access network node.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a ninth example, there is provided an apparatus comprising at least one processor; and at least one memory storing instructions (e.g., computer program code) that, when executed by the at least one processor, cause the apparatus at least to perform: determining that a user equipment will be or has been handed over from a first access network node to the apparatus; determining that the access network node does not support a first congestion control mechanism that is performed by the first access network node; signalling to a core network apparatus an indication that the apparatus does not support the first congestion control mechanism; and receiving, from the core network apparatus, an instruction to provide congestion information to an application function or application server for at least one packet signalled between the user equipment and the second access network node.

The apparatus may be caused to perform: explicitly sending the congestion information to the application function or application server either by using user plane or control plane.

The apparatus may be caused to perform: functions of a second access network node.

The apparatus may be implemented as the first access network node.

The indication that the second access network node does not support the first congestion control mechanism may be comprised in a handover request acknowledgement.

The indication that the second access network node does not support the first congestion control mechanism may be comprised in a path switch request.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a tenth example, there is provided an apparatus comprising at least one processor; and at least one memory storing instructions (e.g., computer program code) that, when executed by the at least one processor, cause the apparatus at least to perform: determining that a user equipment will be or has been handed over from a first cell provided by a first access network node to a second cell provided by a second access network node; and providing, to the second access network node, an indication that the first access network node supports a first congestion control mechanism that is provided by the first access network node.

The apparatus may be caused to perform: functions of the first access network node.

The apparatus may be implemented as the first access network node.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to an eleventh example, there is provided a method for an apparatus, the method comprising: receiving an indication that a user equipment will be or has been handed over from a first access network node to a second access network node, the first access network node being configured to provide a first congestion control mechanism; receiving an indication that the second access network node does not support the first congestion control mechanism; determining that a user plane function is able to perform a second congestion control mechanism; and signalling the user plane function a request to perform the second congestion control mechanism for at least one packet signalled between the user equipment and the second access network node.

The method may comprise signalling an instruction to the second access network node to provide congestion information on said at least one packet to the user plane function that indicates whether the at least one packet experienced congestion.

The determining that the user plane function is able to perform the second congestion control mechanism may comprise receiving an indication from the user plane function that the user plane function is able to perform the second congestion control mechanism.

The first and second congestion control mechanisms may both comprise marking the at least one packet as congested.

The method may comprise determining that a user plane function is unable to perform a second congestion control mechanism.

The first and second congestion control mechanisms may both comprise marking the at least one packet as congested.

The method may comprise performing functions of a session management function.

The method may comprise implementing a virtual network function instance of the session management function.

The method may comprise maintaining session information for a session between an application function or application server and the user equipment via either the first or second access network node.

The indication that the second access network node does not support the first congestion control mechanism may be received from the second access network node.

The indication that the second access network node does not support the first congestion control mechanism may be received via a session update request.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a twelfth example, there is provided a method for an apparatus, the method comprising: receiving an indication that a user equipment will be or has been handed over from a first access network node to a second access network node, the first access network node being configured to provide a first congestion control mechanism; receiving an indication that the second access network node does not support the first congestion control mechanism; determining that a second access network node is able to perform a third congestion control mechanism; and signalling to the second access network node an instruction to perform the third congestion control mechanism for at least one packet signalled between the second access network node and the user equipment.

The method may comprise determining that a user plane function is unable to perform a second congestion control mechanism.

The first and second congestion control mechanisms may both comprise marking the at least one packet as congested.

The method may comprise performing functions of a session management function.

The method may comprise implementing a virtual network function instance of the session management function.

The method may comprise maintaining session information for a session between an application function or application server and the user equipment via either the first or second access network node.

The indication that the second access network node does not support the first congestion control mechanism may be received from the second access network node.

The indication that the second access network node does not support the first congestion control mechanism may be received via a session update request.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a thirteenth example, there is provided a method for an apparatus, the method comprising: determining that a user equipment will be or has been handed over from a first access network node to the apparatus; determining that the apparatus does not support a first congestion control mechanism that is performed by the first access network node; signalling to a core network node an indication that the apparatus does not support the first congestion control mechanism; and receiving, from the core network node, an instruction to provide congestion information to a user plane function for at least one packet signalled between the user equipment and the second access network node.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a fourteenth example, there is provided a method for an apparatus, the method comprising: determining that a user equipment will be or has been handed over from a first access network node to the apparatus; determining that the access network node does not support a first congestion control mechanism that is performed by the first access network node; signalling to a core network apparatus an indication that the apparatus does not support the first congestion control mechanism; and receiving, from the core network apparatus, an instruction to provide congestion information to an application function or application server for at least one packet signalled between the user equipment and the second access network node.

The method may comprise explicitly sending the congestion information to the application function or application server either by using user plane or control plane.

The method may comprise performing functions of a second access network node.

The apparatus may be implemented as the first access network node.

The indication that the second access network node does not support the first congestion control mechanism may be comprised in a handover request acknowledgement.

The indication that the second access network node does not support the first congestion control mechanism may be comprised in a path switch request.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a fifteenth example, there is provided a method for an apparatus, the method comprising: determining that a user equipment will be or has been handed over from a first cell provided by a first access network node to a second cell provided by a second access network node; and providing, to the second access network node, an indication that the first access network node supports a first congestion control mechanism that is provided by the first access network node.

The method may comprise performing functions of the first access network node.

The apparatus may be implemented as the first access network node.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a sixteenth example, there is provided an apparatus comprising: receiving circuitry for receiving an indication that a user equipment will be or has been handed over from a first access network node to a second access network node, the first access network node being configured to provide a first congestion control mechanism; receiving circuitry for receiving an indication that the second access network node does not support the first congestion control mechanism; determining circuitry for determining that a user plane function is able to perform a second congestion control mechanism; and signalling circuitry for signalling the user plane function a request to perform the second congestion control mechanism for at least one packet signalled between the user equipment and the second access network node.

The apparatus may comprise signalling circuitry for signalling an instruction to the second access network node to provide congestion information on said at least one packet to the user plane function that indicates whether the at least one packet experienced congestion.

The determining circuitry for determining that the user plane function is able to perform the second congestion control mechanism may comprise receiving circuitry for receiving an indication from the user plane function that the user plane function is able to perform the second congestion control mechanism.

The first and second congestion control mechanisms may both comprise marking the at least one packet as congested.

The apparatus may comprise determining circuitry for determining that a user plane function is unable to perform a second congestion control mechanism.

The first and second congestion control mechanisms may both comprise marking the at least one packet as congested.

The apparatus may comprise performing circuitry for performing functions of a session management function.

The apparatus may comprise implementing circuitry for implementing a virtual network function instance of the session management function.

The apparatus may comprise maintaining circuitry for maintaining session information for a session between an application function or application server and the user equipment via either the first or second access network node.

The indication that the second access network node does not support the first congestion control mechanism may be received from the second access network node.

The indication that the second access network node does not support the first congestion control mechanism may be received via a session update request.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a seventeenth example, there is provided an apparatus comprising: receiving circuitry for receiving an indication that a user equipment will be or has been handed over from a first access network node to a second access network node, the first access network node being configured to provide a first congestion control mechanism; receiving circuitry for receiving an indication that the second access network node does not support the first congestion control mechanism; determining circuitry for determining that a second access network node is able to perform a third congestion control mechanism; and signalling circuitry for signalling to the second access network node an instruction to perform the third congestion control mechanism for at least one packet signalled between the second access network node and the user equipment.

The apparatus may comprise determining circuitry for determining that a user plane function is unable to perform a second congestion control mechanism.

The first and second congestion control mechanisms may both comprise marking the at least one packet as congested.

The apparatus may comprise performing circuitry for performing functions of a session management function.

The apparatus may comprise implementing circuitry for implementing a virtual network function instance of the session management function.

The apparatus may comprise maintaining circuitry for maintaining session information for a session between an application function or application server and the user equipment via either the first or second access network node.

The indication that the second access network node does not support the first congestion control mechanism may be received from the second access network node.

The indication that the second access network node does not support the first congestion control mechanism may be received via a session update request.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to an eighteenth example, there is provided an apparatus comprising: determining circuitry for determining that a user equipment will be or has been handed over from a first access network node to the apparatus; determining circuitry for determining that the apparatus does not support a first congestion control mechanism that is performed by the first access network node; signalling circuitry for signalling to a core network node an indication that the apparatus does not support the first congestion control mechanism; and receiving circuitry for receiving, from the core network node, an instruction to provide congestion information to a user plane function for at least one packet signalled between the user equipment and the second access network node.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a nineteenth example, there is provided an apparatus comprising: determining circuitry for determining that a user equipment will be or has been handed over from a first access network node to the apparatus; determining circuitry for determining that the access network node does not support a first congestion control mechanism that is performed by the first access network node; signalling circuitry for signalling to a core network apparatus an indication that the apparatus does not support the first congestion control mechanism; and receiving circuitry for receiving, from the core network apparatus, an instruction to provide congestion information to an application function or application server for at least one packet signalled between the user equipment and the second access network node.

The apparatus may comprise sending circuitry for explicitly sending the congestion information to the application function or application server either by using user plane or control plane.

The apparatus may comprise performing circuitry for performing functions of a second access network node.

The apparatus may be implemented as the first access network node.

The indication that the second access network node does not support the first congestion control mechanism may be comprised in a handover request acknowledgement.

The indication that the second access network node does not support the first congestion control mechanism may be comprised in a path switch request.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a twentieth example, there is provided an apparatus comprising: determining circuitry for determining that a user equipment will be or has been handed over from a first cell provided by a first access network node to a second cell provided by a second access network node; and providing circuitry for providing, to the second access network node, an indication that the first access network node supports a first congestion control mechanism that is provided by the first access network node.

The apparatus may comprise performing circuitry for performing functions of the first access network node.

The apparatus may be implemented as the first access network node.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a twenty first example, there is provided non-transitory computer readable medium comprising program instructions for causing an apparatus to perform: receiving: receiving an indication that a user equipment will be or has been handed over from a first access network node to a second access network node, the first access network node being configured to provide a first congestion control mechanism; receiving an indication that the second access network node does not support the first congestion control mechanism; determining that a user plane function is able to perform a second congestion control mechanism; and signalling the user plane function a request to perform the second congestion control mechanism for at least one packet signalled between the user equipment and the second access network node.

The apparatus may be caused to perform: signalling an instruction to the second access network node to provide congestion information on said at least one packet to the user plane function that indicates whether the at least one packet experienced congestion.

The determining that the user plane function is able to perform the second congestion control mechanism may comprise receiving an indication from the user plane function that the user plane function is able to perform the second congestion control mechanism.

The first and second congestion control mechanisms may both comprise marking the at least one packet as congested.

The apparatus may be caused to perform: determining that a user plane function is unable to perform a second congestion control mechanism.

The first and second congestion control mechanisms may both comprise marking the at least one packet as congested.

The apparatus may be caused to perform: functions of a session management function.

The apparatus may be caused to perform: implementing a virtual network function instance of the session management function.

The apparatus may be caused to perform: maintaining session information for a session between an application function or application server and the user equipment via either the first or second access network node.

The indication that the second access network node does not support the first congestion control mechanism may be received from the second access network node.

The indication that the second access network node does not support the first congestion control mechanism may be received via a session update request.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a twenty second example, there is provided non-transitory computer readable medium comprising program instructions for causing an apparatus to perform: receiving an indication that a user equipment will be or has been handed over from a first access network node to a second access network node, the first access network node being configured to provide a first congestion control mechanism; receiving an indication that the second access network node does not support the first congestion control mechanism; determining that a second access network node is able to perform a third congestion control mechanism; and signalling to the second access network node an instruction to perform the third congestion control mechanism for at least one packet signalled between the second access network node and the user equipment.

The apparatus may be caused to perform: determining that a user plane function is unable to perform a second congestion control mechanism.

The first and second congestion control mechanisms may both comprise marking the at least one packet as congested.

The apparatus may be caused to perform: functions of a session management function.

The apparatus may be caused to perform: implementing a virtual network function instance of the session management function.

The apparatus may be caused to perform: maintaining session information for a session between an application function or application server and the user equipment via either the first or second access network node.

The indication that the second access network node does not support the first congestion control mechanism may be received from the second access network node.

The indication that the second access network node does not support the first congestion control mechanism may be received via a session update request.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a twenty third example, there is provided non-transitory computer readable medium comprising program instructions for causing an apparatus to perform: determining that a user equipment will be or has been handed over from a first access network node to the apparatus; determining that the apparatus does not support a first congestion control mechanism that is performed by the first access network node; signalling to a core network node an indication that the apparatus does not support the first congestion control mechanism; and receiving, from the core network node, an instruction to provide congestion information to a user plane function for at least one packet signalled between the user equipment and the second access network node.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a twenty fourth example, there is provided non-transitory computer readable medium comprising program instructions for causing an apparatus to perform: determining that a user equipment will be or has been handed over from a first access network node to the apparatus; determining that the access network node does not support a first congestion control mechanism that is performed by the first access network node; signalling to a core network apparatus an indication that the apparatus does not support the first congestion control mechanism; and receiving, from the core network apparatus, an instruction to provide congestion information to an application function or application server for at least one packet signalled between the user equipment and the second access network node.

The apparatus may be caused to perform: explicitly sending the congestion information to the application function or application server either by using user plane or control plane.

The apparatus may be caused to perform: functions of a second access network node.

The apparatus may be implemented as the first access network node.

The indication that the second access network node does not support the first congestion control mechanism may be comprised in a handover request acknowledgement.

The indication that the second access network node does not support the first congestion control mechanism may be comprised in a path switch request.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a twenty fifth example, there is provided non-transitory computer readable medium comprising program instructions for causing an apparatus to perform: determining that a user equipment will be or has been handed over from a first cell provided by a first access network node to a second cell provided by a second access network node; and providing, to the second access network node, an indication that the first access network node supports a first congestion control mechanism that is provided by the first access network node.

The apparatus may be caused to perform: functions of the first access network node.

The apparatus may be implemented as the first access network node.

The first congestion control mechanism may comprise an access network node explicitly marking packets as congested when there is determined to be congestion between a cell provided by the access network node and the user equipment.

The second congestion control mechanism may comprise a user plane function explicitly marking packets as congested when there is determined to be congestion between the cell provided by the access network node and the user equipment.

The third congestion control mechanism may comprise an access network node sending explicit congestion information to an application function or an application server either via Control Plane or User Plane, when there is determined to be congestion between the cell provided by the access network node and the user equipment.

The first and/or second congestion control mechanism may comprise a low latency low loss and scalable throughput congestion control mechanism.

According to a twenty sixth aspect, there is provided a computer program product stored on a medium that may cause an apparatus to perform any method as described herein.

According to a twenty seventh aspect, there is provided an electronic device that may comprise apparatus as described herein.

According to a twenty eighth aspect, there is provided a chipset that may comprise an apparatus as described herein.
[to be completed when claims agreed]

### BRIEF DESCRIPTION OF FIGURES

Some examples, will now be described, merely by way of illustration only, with reference to the accompanying drawings in which:

FIG. 1 shows an example representation of a 5G system;

FIG. 2 shows an example representation of a network apparatus;

FIG. 3 shows an example representation of a user equipment;

FIG. 4 shows an example network;

FIGS. 5 to 7 show example signalling; and

FIGS. 8 to 12 show example operations that may be performed by apparatus.

### DETAILED DESCRIPTION

The following describes example operations that may be performed in relation to mobility events, such as cell changes, in a radio access network.

In some examples, it is disclosed how to continue to provide support for indicating when packets transmitted by a user equipment are being transmitted in a congested radio access network environment during handover of the user equipment from a first cell provided by a first radio access network node to a second cell provided by a second radio access network node where the first and second radio access network nodes do not have the same congestion control capabilities.

In the following, certain examples are explained with reference to devices that are often capable of communication via a wireless cellular system and mobile communication systems serving such mobile communication devices. For brevity and clarity, the following describes such examples with reference to a 5G wireless communication system. However, it is understood that such examples are not limited to 5G wireless communication systems, and may, for example, be applied to other wireless communication systems (e.g., current 6G proposals, IEEE 802.11, among others).

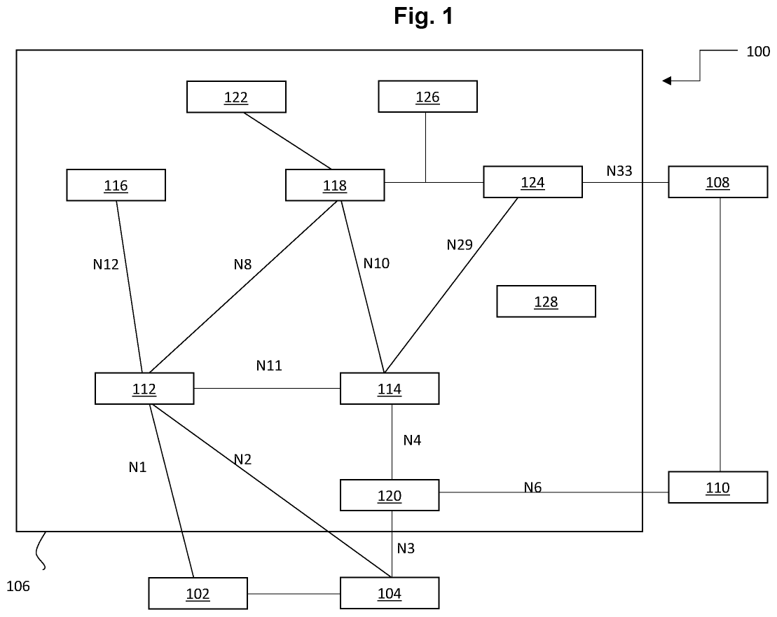

Before describing in detail the examples, certain general facets of a 5G wireless communication system are briefly explained with reference to FIGS. 1 to 3.

FIG. 1 shows an example representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

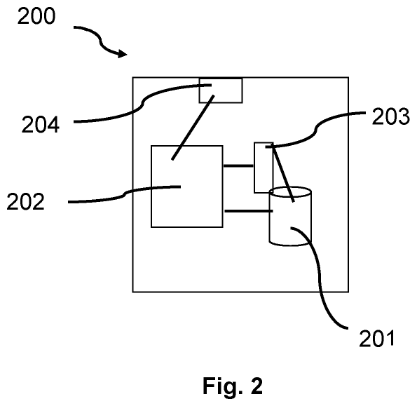

FIG. 2 shows an example of a control apparatus for a communication system, for example to be coupled to and/or for controlling a station of an access system, such as a RAN node, e.g. a base station, gNB, a central unit of a cloud architecture or a node of a core network such as an AMF or UPF, a scheduling entity such as a spectrum management entity, or a server or host, for example an apparatus hosting an NRF, NWDAF, AMF, SMF, UDM/UDR, and so forth. The control apparatus may be integrated with or external to a node or module of a core network or RAN. In some examples, base stations comprise a separate control apparatus unit or module. In other examples, the control apparatus can be another network element, such as a radio network controller or a spectrum controller. The control apparatus 200 can be configured to provide control on communications in the service area of the system. The apparatus 200 comprises at least one memory 201, at least one data processing unit 202, 203 and an input/output interface 204. Via the interface, the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions. References to “code” herein are understood to refer to software code, and vice versa.

The station of the access system may be categorised into two different types: distributed units (DUs), and centralised units (CUs).

A DU provides access network node support for lower layers of the protocol stack (e.g., the radio link control (RLC), medium access control (MAC), and/or physical layer protocol layers). Each DU is able to support one or more cells, while each cell is able to support one or more beams.

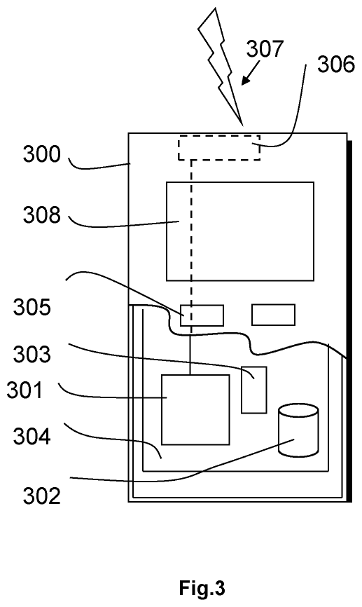

An example wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is referred to as a ‘smart phone’, a computer provided with a wireless interface card or other wireless interface facility (e.g., USB dongle), personal data assistant (PDA) or a tablet provided with wireless communication capabilities, or a Virtual Reality device, Augmented Reality device, Mixed Reality device, or other Extended Reality device, such as a virtual reality headset, or any combinations of these or the like. A mobile communication device may provide, for example, communication of data for carrying communications such as voice, electronic mail (email), text message, multimedia, extended reality media, and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may, for example, be a mobile device, that is, a device not fixed to a particular location, or it may be a stationary device. The wireless device may utilize human interaction for communication, or may not utilize human interaction for communication. As described herein, the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be configured internally or externally to the wireless device.

A wireless device is typically provided with at least one data processing entity 301, at least one memory 302 and other possible components 303 for use in software code and hardware aided execution of Tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface such as keypad 305, voice commands, touch sensitive screen or pad, combinations thereof or the like. A display (e.g., virtual reality headset/glasses) 308, a speaker and a microphone can be also provided. Furthermore, a wireless communication device may comprise appropriate connectors (either wired or wireless) to other devices and/or for connecting external accessories, for example hands-free equipment, thereto.

The wireless apparatus of FIG. 3 may comprise a user equipment. The user equipment (UE) may include a wireless or mobile device, an apparatus with a radio interface to interact with a RAN (Radio Access Network), a smartphone, an in-vehicle apparatus, an loT device, a M2M device, or else. Such UE or apparatus may comprise: at least one processor; and at least one memory storing instructions (e.g., computer program code) that, when executed by the at least one processor, cause the apparatus at least to perform certain operations, like e.g. RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units).

The UE may have different states (e.g., according to 3GPP TS 38.331 V16.5.0 (2021-06) sections 42.1 and 4.4, incorporated by reference).

A UE is e.g., either in RRC_CONNECTED state or in RRC_INACTIVE state when an RRC connection has been established.

In RRC_CONNECTED state a UE may:
store the AS context;
transfer unicast data to/from the UE;
monitor control channels associated with the shared data channel to determine if data is scheduled for the data channel;
provide channel quality and feedback information;
perform neighboring cell measurements and measurement reporting.

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

3GPP has issued a number of releases (Rel) for defining operating communication protocols related to a communications network. Currently, objectives and work are being set in relation to Release 18 (Rel. 18).

One of the schemes currently being considered relates to a low-latency, low-loss scalable throughput (L4S) service.

The L4S service is intended to enable a class of congestion controls that includes explicit congestion signaling from the network.

L4S was described in an Internet Engineering Task Force (IETF) draft. L4S uses an Active Queue Management (AQM)-like mechanism that, instead of dropping packets, uses link state indications and rate adjustments that are proportional to a determined queue delay.

An L4S service allows network administrators to configure their router's AQM scheme to mark the packets as per congestion experienced (CE) when a queueing delay threshold defined in the AQM scheme is exceeded. CE is a coding mechanism that may be used to indicate and/or identify which packets of an IP flow are transmitted in accordance with L4S. CE (and L4S) are described further in IETF RFC 9331 and IETF RFC 19330.

L4S-compatible transport and/or higher layers in the transmitting apparatus may deduce an amount of congestion by the ratio of the number of normal packets prepared to the number of CE-marked packets prepared. The apparatus may reduce the sending rate accordingly. During normal operation, this method may avoid packet drops caused by congestion and retain high utilization and low latency.

In more detail, L4S is an evolution of ECN (Explicit Congestion Notification). ECN is described in more detail below, but in general, ECN is directed towards providing low queue delay and low loss in congested nodes at a range of bitrates, including high bitrates. This may be useful for certain applications such as, for example, real-time applications, including Augmented reality/Virtual reality (AR/VR) applications. L4S traffic can be differentiated from classic (e.g., non-L4S) traffic by the inclusion of bits on the Internet Protocol (IP) layer that explicitly indicates that congestion is being experienced. These bits are called ECN bits herein. ECN mechanisms do not use any deep packet inspection for the identification.

There are three main components to an L4S architecture: an AQM mechanism in a network, congestion control on a host, and a communication protocol therebetween.

ECN relates to an algorithm whose goal is to inform the sender about congestion building at the routers. Hence, ECN may be considered to be a congestion notification or congestion signaling algorithm. ECN was introduced in RFC3168. ECN informs the sender about congestion so that respective measures can be taken to avoid that. ECN may be used as part of an L4S scheme. ECN algorithm informs the sender about congestion building at the routers. To enable ECN bits marking for L4S, an existing or a separate Quality of Service (QOS) flow can be used for L4S traffic.

To support extended Reality (XR) in 3GPP networks, study aims in Rel-18 have been directed towards mechanisms that enable codec and/or rate adaptation to meet constraints for services (e.g., XR. Media services). This adaption may be made based on (e.g., in response to) congestion detection, with information indicating that the network is congested (e.g., congestion information) being conveyed from a network to an application configured to send information over the congested network.

In particular, two ways in which congestion information can be conveyed back to the application for adapting the transmission rate have been identified. These are discussed further below.

In a first example option, the 5G System may use ECN marking for the purpose of L4S for uplink and/or downlink quality of flow (QoS) Flows. For the second example option, the 5G System may support application programming interface (API)-based exposure of congestion level information towards AF. API-based exposure (e.g., notification) may be performed via a control plane (C-plane) and/or a user plane (U-plane), and may be considered as an alternative congestion notification mechanism to L4S-based ECN marking These two options will be discussed in turn.

For the first example option, a network-based entity can explicitly mark packets that are experiencing congestion. This marking may be performed by a radio access network node (option 1, method 1) and/or by a user plane function (option 1, method 2).

For option 1, method 1, the NG-RAN may allow for ECN marking to be included in uplink and/or downlink signalling (e.g., in an Internet Protocol (IP) layer of the received packets). The criteria for the RAN to determine its congestion level when performing the marking may be up to RAN implementation.

For option 1, method 2, the PSA user plane function may perform ECN marking for uplink and downlink transmission of the received packets (e.g., in an IP layer) based on latest reported congestion information. The latest reported congestion information may be obtained from the NG-RAN (e.g., via a General Packet Radio Services (GPRS) Tunnelling Protocol-User Plane (GTP-U) header). When no congestion/congestion ends, the PSA UPF may stop ECN marking. Further, when no uplink packet is provided when a congestion report is needed (e.g. for downlink congestion), the NG-RAN may generate a dummy uplink packet for such a reporting.

The specification of the mobility scenario for both methods may be for further study.

For both methods 1 and 2, ECN marking for L4S may be per QoS flow. In order to map a packet flow that can be subject to ECN marking for L4S to a QoS flow with ECN marking for L4S support, the traffic detection may be used at a UPF. For traffic detection, the packet filters may either reuse existing IP-5 tuples, or ECN Capable Transport (ECT). A IP 5-tuple may comprise the set (source IP address, source port, destination IP address, destination port, transport protocol).

When the network operator wants to apply the ECN marking for L4S, the network operator may guarantee that any sender (whether UE or Server) requesting classic ECN congestion control will not tag its packets with the ECT in order to avoid conflicted usage of ECT in L4S. If this backwards compatibility is not guaranteed, L4S is not supported in network.

The two mechanisms for this option may support L4S and for exposure of congestion information is pending RAN WG's feedback on the feasibility of RAN judgment and/or exposure of the corresponding info (e.g. per QoS flow congestion information).

For the second example option, the 5G System also may support application programming interface (API)-based exposure of congestion level information towards the AF as following.

First, the RAN may expose the following information:
Quality of Service (QOS) Notification Control (QNC) for guaranteed bit rate (GBR) QOS Flow: data rate cannot be guaranteed.
RAN provides the congestion information of uplink and downlink to PSA UPF enabling PSA UPF to perform API exposure towards an application function (AF) and/or ECN marking for L4S;
AF uses Nnef_AFSessionWithQoS to subscribe the above exposure to NEF/PCF, same as local exposure mechanism defined in TS 23.548[61].
Exposure path of Network Exposure defined in clause 6.4 of TS 23.548 is reused with extensions of GTP-U header and UPF/NEF services to exposure the above information.
Exposure path of RAN/UPF reporting congestion level information via SMF/PCF/NEF is also supported.

The network deployments may not be homogeneous in terms of the capability of the nodes to support L4S. L4S implementation may, for instance, result in the routers (and hosts) either having L4S capability or having to upgrade to L4S capability.

L4S capability in a node may include at least one of: ECN marking capability, ECT identification, L4S-AQM algorithm deployment, optional dual queue (one for L4S traffic, one for other traffic), or special computation capability.

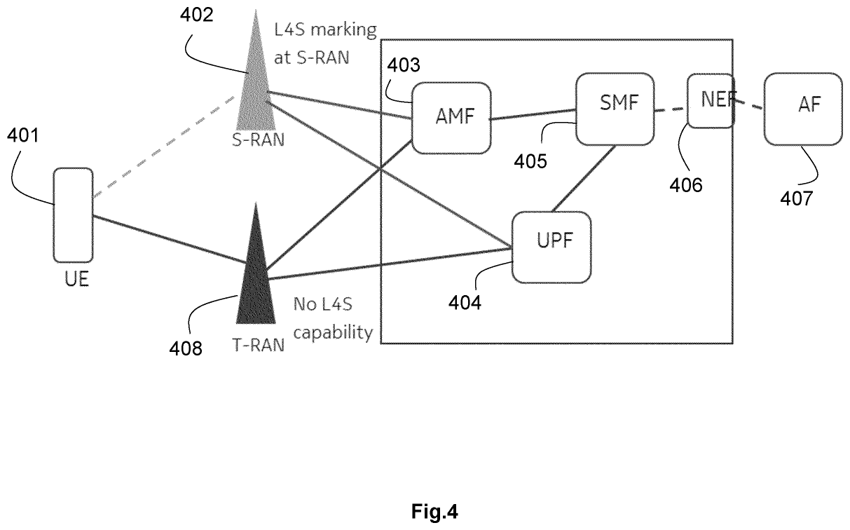

As the network deployments may not be homogeneous in terms of the capability of the nodes to support L4S, it is possible that not all nodes in a network (e.g., a RAN node and/or a UPF node) are L4S enabled. An example of this is illustrated in FIG. 4.

FIG. 4 illustrates a UE 401 that is connected to a source-RAN node 402 that allows L4S marking. The source-RAN may communicate with a core part of a 5G network via an AMF 403 and/or a UPF 404. The 5G core further comprises an SMF 405, and an NEF 406 that can interface with an application function 407 outside of the 5GC. FIG. 4 further illustrates a target RAN node 408, to which the UE is triggered to handover from the source-RAN node 402. The target-RAN node 408 may have no L4S capability. It is assumed that the 5G core network elements (e.g., SMF/AMF/NEF) are capable of managing request to handle L4S traffic. Moreover, enabling L4S based markings at both, the RAN and the UPF for (at least for the same QoS flows) may lead to higher resource consumption (e.g., computation) and further latency.

A range of issues that may arise when the UE moves from a source RAN that was supporting L4S to a target RAN node that does not support L4S.

For example, even when there is congestion, the sender application may assume that there is no more congestion in the network (and hence may not do any rate adaptation). Further, the target RAN node may delay or drop packets due to congestion, and queues may get full without indicating the same to the sender. The experience of the user may be hampered due to jitter whenever there is congestion in the transport path.

Although the impacts for ECN marking for L4S is for future study, some mechanisms have been proposed for mitigating these effects.

For example, when a serving UPF or NG-RAN is changed, the exposure method can be kept or changed according to their capabilities. When the congestion exposure method is changed, the application function may be notified. The entity that notifies the application function is for future study.

None of these proposals have described whether and how the congestion methods may be managed in 5GC and how to handle when one node is not capable of L4S.

As mentioned above, 3GPP TR 23.700-60 outlines two options for communicating congestion information back to the application layer, which can then be utilized for rate adaptation.
Option 1 involves using ECN marking to enable L4S services for uplink and/or downlink QOS Flows. Under this option, there are two methods for implementing ECN marking. Method 1 (First congestion mechanism) involves NG-RAN performing ECN marking for uplink and downlink in the IP layer of received packets, but the criteria for when to perform the marking is up to the RAN implementation. Method 2 (Second congestion mechanism) involves PSA UPF performing ECN marking based on the latest reported congestion information from NG-RAN via GTP-U header, and the marking stops when there is no congestion or congestion ends. Additionally, a QOS Flow level explicit indication may be provided to PSA UPF to enable ECN marking for the purpose of L4S.
Option 2 (Third congestion mechanism) involves supporting API-based exposure of congestion level information towards an AF, which allows an AF to receive and utilize congestion level information from the 5G system.

However, since these options are resource-consuming (e.g., the additional signalling itself may cause more traffic congestion) and computing processor unit (CPU)/Hardware intensive (as a result of deploying L4S in RAN), the following proposes to use only one of these options at a given time. To help facilitate this, the following also proposes mechanisms for ensuring that these options are used in series (i.e., and not in parallel).

It is understood that although the following describes examples of controlling congestion marking in relation to the above-described “three congestion mechanisms”, that analogous mechanisms to those described below may apply in relation to other congestion marking mechanisms.

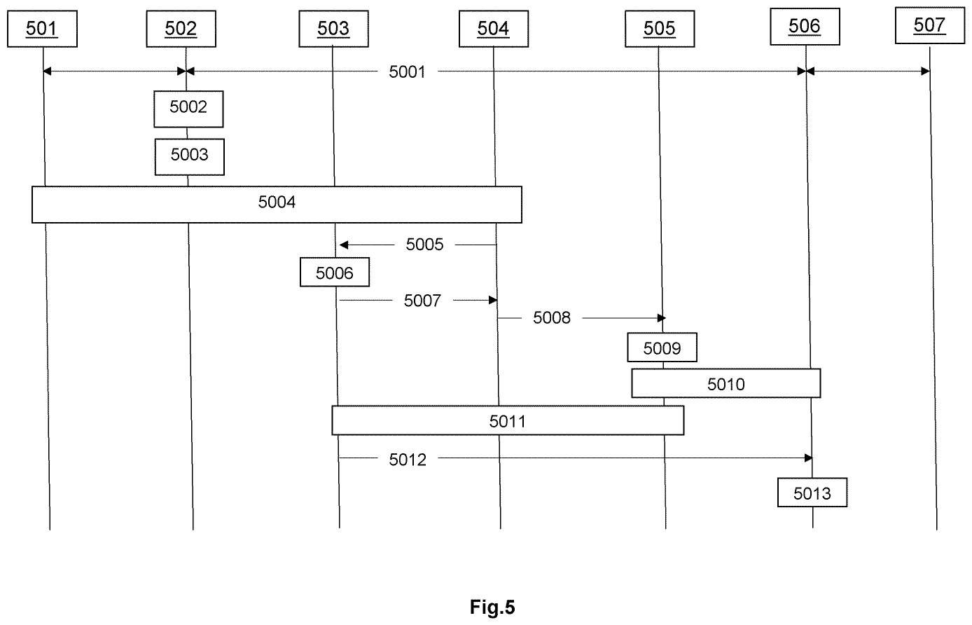

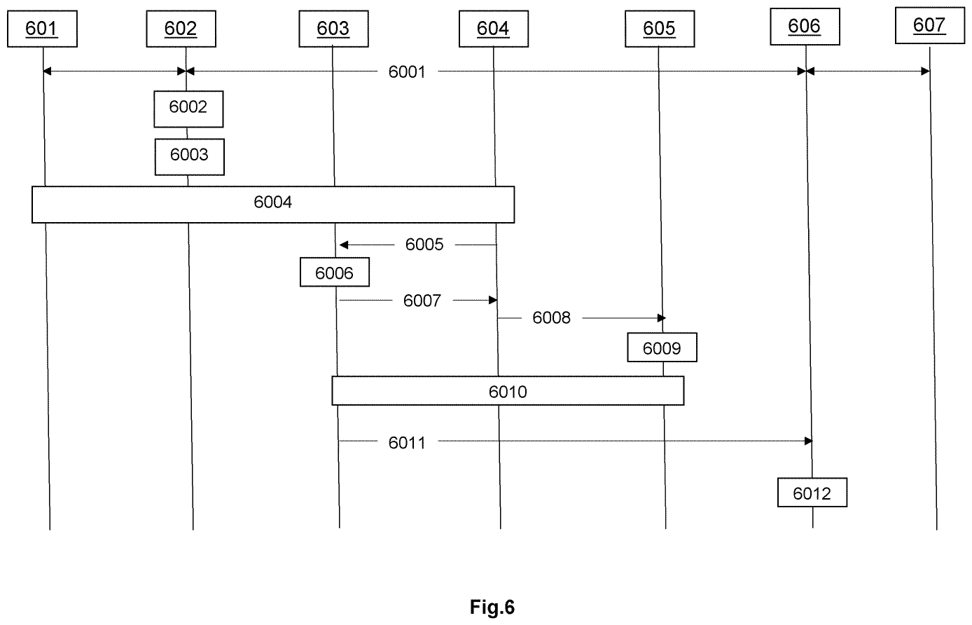

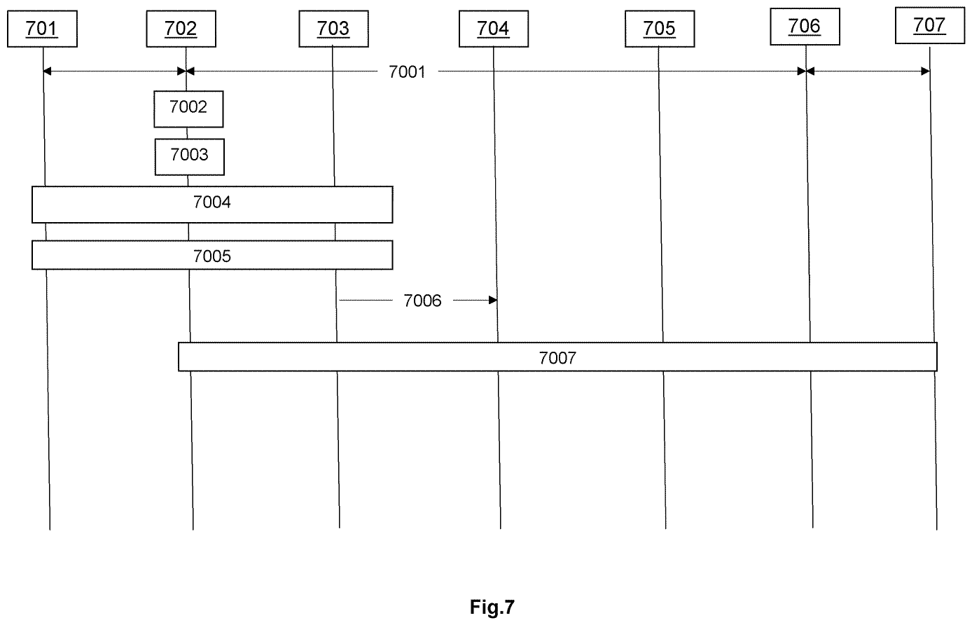

FIGS. 5 to 7 depict example signalling for illustrating the presently described mechanisms. In particular, FIGS. 5 and 6 depict examples relating to an N2 handover scenario. An N2 interface is a control plane interface between an access network node and a 5GC. Therefore, FIGS. 5 and 6 may be said to relate to scenarios in which handover is triggered from a core network entity. In contrast, the example of FIG. 7 depicts an Xn based handover scenario in which handover is controlled at RAN-level entities and/or the UE.

These examples of FIGS. 5 to 7 further assume that the congestion is at the RAN. In particular, even if a UPF is capable of performing congestion marking for L4S schemes, the UPF will not perform the marking unless instructed to do so by a 5GC entity to do the marking on behalf of the RAN node.

FIG. 5 illustrates a UE 501, a source RAN node (S-RAN) 502, a target RAN node (T-RAN) 503, an AMF 504, an SMF 505, a UPF 506, and an application function (AF) 507.

During 5001, the UE 501 exchanges data via the AF 507. This is depicted by signalling extending from the UE 501 to the S-RAN 502, which then passes across the core network that comprises AMF 504, SMF 505, and UPF 506, before being passed through AF 507 (e.g., via an NEF (not shown).

During 5002, the S-RAN determines that the S-RAN is configured to support L4S. In the present example, the S-RAN is configured to apply method 1 of Option 1 (i.e., to have an entity in the RAN perform congestion marking of packets). The S-RAN is therefore configured to perform L4S-based ECN marking on packets when congestion is detected by the S-RAN (e.g., based on congestion being detected by the S-RAN).

During 5003, the S-RAN determines that the UE is to be handed over from a cell provided by the S-RAN 502 to a cell provided by the T-RAN 503. The decision to handover may be based on any of a plurality of different congestion methods. For example, the decision to handover may be based on a layer 3 (e.g., network layer) measurement report transmitted by the UE 501 and/or a layer 1 (e.g., physical layer) measurement report transmitted by the UE 501, and/or a network decision based on a current state of the RAN network(s) that are able to provide a service to the UE 501.

During 5004, the UE 501, S-RAN 502, T-RAN 503, and/or the AMF 504 may initiate (e.g., trigger) a handover procedure to cause the UE to handover from the cell provided by the S-RAN 502 to the T-RAN 503.

During 5005, the AMF 504 signals the T-RAN 503. This signalling may comprise a handover request in respect of the handover trigger during 5004.

During 5006, the T-RAN 504 determines that the T-RAN 504 does not support L4S-based ECN marking. The T-RAN 504 may further determine (e.g., from context shared from the S-RAN), that the S-RAN 503 supports L4S-based ECN marking.

The T-RAN may obtain information indicating whether the S-RAN supports L4S-based ECN marking in at least one of a plurality of different ways. For example, in current handover procedures, the source RAN services for the UE are communicated to T-RAN. Therefore, the T-RAN may be provided with information indicating whether the S-RAN was providing an L4S service prior to handover to the T-RAN with this information regarding the source RAN services. As another example, this information indicating whether the S-RAN was providing an L4S service prior to handover to the T-RAN may be provided via a different (e.g., separate) signalling mechanism.

During 5007, the T-RAN 504 signals the AMF 505. This signalling may acknowledge the handover request of 5005. This signalling may comprise an explicit indication that the T-RAN 504 does not support L4S-based ECN marking. It's understood that although this explicit indication is illustrated as being comprised in a handover acknowledgement, that this explicit indication may instead be comprised in any of a plurality of alternative signals. For example, the explicit indication may be received in response to a request for this information signalled from the AMF to the T-RAN. It is understood this this may also be the case for the examples of FIGS. 6 and 7.

During 5008, the AMF 505 signals the SMF 506. This signalling may comprise a request to update the session context associated with the UE 501 to reflect the change in cell used by the UE 501. This signalling may comprise an indication that the T-RAN 504 does not support L4S-based ECN marking. This signalling may comprise an NsmfPDUSessionUpdate SM Context request service operation.

During 5009, the SMF determines that to switch from marking the packets (when congested) at a RAN node to marking them at a UPF (e.g., to switch from the first method to the second method).

During 5010, the SMF 505 signals the UPF 506. This signalling may comprise an indication to trigger the UPF to start L4S marking. This indication may be referred to herein as an L4S enable indication. This signaling may comprise an N4 session modification request service operation for carrying this indication. This signalling may be performed when the SMF 505 determines that the UPF 506 is not currently performing the L4S congestion marking, although it is understood that the SMF 505 does not necessarily perform this determination.

During 5011, the SMF 505 causes the T-RAN 503 to be signalled. This signalling may instruct the T-RAN 503 to start congestion exposure to the UPF 506 (e.g., to provide congestion information to the UPF 506). in the GTP-U header information.

During 5012, the T-RAN 503 signals congestion information to the UPF 506. This congestion information may be signalled in, for example, a GTP-U header. The congestion information may indicate whether or not there is congestion in the T-RAN 503.

During 5013, the UPF starts performing L4S congestion marking (e.g., ECN marking) using the congestion information provided during 5012.

Therefore, in this example of FIG. 5, the apparatuses act to switch the entity that performs an ECN marking mechanism from a RAN entity to a core network entity (e.g., UPF).

In such a case, the target RAN node may notify an entity in the 5GC (e.g., the SMF and/or PCF) that the target RAN node does not support L4S. The 5GC entity may then instruct the target RAN node to start sending the congestion information to the UPF so that UPF can start ECN marking. The target RAN node may subsequently begin to report the congestion information to the UPF (e.g., in a GTP-U header to the UPF).

It is understood that when it is determined that the UPF is also not L4S capable, that the SMF may instead cause the third congestion method to be performed (e.g., API-based method). This mechanism is illustrated below in relation to FIG. 6.

As a variation to the example of FIG. 5, instead of the target-RAN signalling the SMF directly with its indication that it does not provide support for L4S ECN marking, the target RAN may instead signal it may also possible that the target RAN instead provides this indication to the source RAN node, which subsequently provides it to the SMF.

The above-example of FIG. 5 (and its variation) may provide certain advantages in the event that the UPF is expected to change, as the same operations apply.

FIG. 6 illustrates an example related to congestion method 3 (e.g., to a situation in which both a target RAN and a UPF are unable to support L4S congestion marking, while an S-RAN does support L4S congestion marking).

FIG. 6 illustrates a UE 601, a source RAN node (S-RAN) 602, a target RAN node (T-RAN) 603, an AMF 604, an SMF 605, a UPF 606, and an application function (AF) 607.

During 6001, the UE 601 exchanges data via the AF 607. This is depicted by signalling extending from the UE 601 to the S-RAN 602, which then passes across the core network that comprises AMF 604, SMF 605, and UPF 606, before being passed through AF 607 (e.g., via an NEF (not shown)).

During 6002, the S-RAN determines that the S-RAN is configured to support L4S. In the present example, the S-RAN is configured to apply method 1 of Option 1 (e.g., to perform congestion marking of packets at the S-RAN). The S-RAN is therefore configured to perform L4S-based ECN marking on packets when congestion is detected by the S-RAN (e.g., based on congestion being detected by the S-RAN).

During 6003, the S-RAN determines that the UE is to be handed over from a cell provided by the S-RAN 602 to a cell provided by the T-RAN 603. The decision to handover may be based on any of a plurality of different congestion methods. For example, the decision to handover may be based on a layer 3 (e.g., network layer) measurement report transmitted by the UE 601 and/or a layer 1 (e.g., physical layer) measurement report transmitted by the UE 601, and/or a network decision based on a current state of the RAN network(s) that are able to provide a service to the UE 601.

During 6004, the UE 601, S-RAN 602, T-RAN 603, and/or the AMF 604 may initiate (e.g., trigger) a handover procedure to cause the UE to handover from the cell provided by the S-RAN 602 to the T-RAN 603.

During 6005, the AMF 604 signals the T-RAN 603. This signalling may comprise a handover request with respect to (e.g., based on) the handover trigger during 6004.

During 6006, the T-RAN 604 determines that the T-RAN 604 does not support L4S-based ECN marking. The T-RAN 604 may further determine (e.g., from context shared from the S-RAN), that the S-RAN 603 supports L4S-based ECN marking.

The T-RAN may obtain information indicating whether the S-RAN supports L4S-based ECN marking in at least one of a plurality of different ways. For example, in current handover procedures, the source RAN services for the UE are communicated to T-RAN. Therefore, the T-RAN may be provided with information indicating whether the S-RAN was providing an L4S service prior to handover to the T-RAN with this information regarding the source RAN services. As another example, this information indicating whether the S-RAN was providing an L4S service prior to handover to the T-RAN may be provided via a different (e.g., separate) signalling mechanism.

During 6007, the T-RAN 604 signals the AMF 605. This signalling may acknowledge the handover request of 6005. This signalling may comprise an explicit indication that the T-RAN 604 does not support L4S-based ECN marking.

It's understood that although this explicit indication is illustrated as being comprised in a handover acknowledgement, that this explicit indication may instead be comprised in any of a plurality of alternative signals. For example, the explicit indication may be received in response to a request for this information signalled from the AMF to the T-RAN. It is understood this this may also be the case for the examples of FIGS. 5 and 7.

During 6008, the AMF 605 signals the SMF 606. This signalling may comprise a request to update the session context associated with the UE 601 to reflect the change in cell used by the UE 601. This signalling may comprise an indication that the T-RAN 604 does not support L4S-based ECN marking. This signalling may comprise an NsmfPDUSessionUpdate SM Context request service operation.

During 6009, the SMF 605, the SMF determines to switch from option 1 (e.g., L4S-based congestion marking) to option 2 (e.g., API-based congestion exposure). This may be performed when the SMF 605 can determine that the UPF also does not support L4S for ECN marking. It is understood that although this is described in relation to the SMF making this determination, that some other network entity (e.g., 5GC network entity) may make this determination (e.g., a PCF and/or an application function).

During 6010, the SMF may signal the T-RAN 603. This signalling may comprise (or otherwise indicate) an instruction to the T-RAN to start sending the congestion information to the application function (not shown) via the C-plane, i.e, SMF 605 or via U-plane, i.e, user plane function.

Subsequently, during 6011, the T-RAN 603 signals the congestion information to the SMF 605.

During 6012, the SMF 605 notifies the AF 607 regarding congestion in the network. The signalling of 6011 to 6012 collectively represents the T-RAN 603 sending an explicit indication of congestion information to the application function using at least one of user plane signalling and/or control plane signalling. Therefore, in the example of FIG. 6, the T-RAN does not mark data packets that have experienced congestion as congested. Instead, the T-RAN provides a separate signal to inform the application function of the congestion.

In the example of FIG. 6, the SMF may switch congestion notification mechanism from ECN marking for L4S based to API-based exposure (e.g., from option-1 to option-2). The SMF may indicate to the target NG-RAN to switch to a control-plane congestion notification. The SMF may then instruct the NG-RAN to start sending the congestion information to the SMF. The SMF, in turn, may provide the congestion information to the AF (e.g., via NEF).

In a variation to this, the SMF may instruct the UPF that the UPF is to provide API-based congestion marking (e.g., that the system will switch from option 1 to option 2 for congestion notification). The SMF may further indicate to the target NG-RAN that a switch to congestion notification via the UPF (U-plane) is to be performed. The UPF, in turn, may provide congestion information to the AF (e.g., via an NEF).

The SMF 605 may perform variations of this signalling of FIG. 6 depending on whether the API-exposure is control plane-based or user plane-based.

For example, for control-plane based API exposure, the SMF may instruct the T-RAN to start sending the congestion information to the AF via the SMF (e.g., during 6010). In contrast, for user-plane-based exposure, the SMF does not perform the signalling of 6010. Subsequently, instead of performing the signalling of 6011-6012 (which is performed in the event of control plane based API exposure, for U-plane based API-exposure), the SMF instead instructs the UPF to expose congestion via an application programming interface (API) directly to the AF (e.g., via an NEF, not shown).

The periodicity of how often the congestion information is shared from the T-RAN to the AF may be implementation specific.

As a variation to the example of FIG. 6, instead of the target-RAN signalling the SMF directly with its indication that it does not provide support for L4S ECN marking, the target RAN may instead signal it may also possible that the target RAN instead provides this indication to the source RAN node, which subsequently provides it to the SMF.

The above-example of FIG. 6 (and its variation) may provide certain advantages in the event that the UPF is expected to change, as the same operations may apply.

As mentioned above, the example of FIG. 7 relates to a scenario in which RAN-level entities determine when a handover is to be triggered, and do not rely on signalling that passes through a core network (as per the examples of FIGS. 5 and 6). Therefore, the primary difference between FIG. 7 and FIGS. 5 and 6 is the signalling mechanism through which the T-RAN indicates its ECN marking capability to the AMF.

FIG. 7 illustrates a UE 701, a source RAN node (S-RAN) 702, a target RAN node (T-RAN) 703, an AMF 704, an SMF 705, a UPF 706, and an application function (AF) 707.

During 7001, the UE 701 exchanges data via the AF 707. This is depicted by signalling extending from the UE 701 to the S-RAN 702, which then passes across the core network that comprises AMF 704, SMF 705, and UPF 706, before being passed through AF 707 (e.g., via an NEF (not shown).

During 7002, the S-RAN determines that the S-RAN is configured to support L4S. In the present example, the S-RAN is configured to apply method 1 of Option 1 (e.g., to perform congestion marking of packets at the S-RAN). The S-RAN is therefore configured to perform L4S-based ECN marking on packets when congestion is detected by the S-RAN.

During 7003, the S-RAN determines that the UE is to be handed over from a cell provided by the S-RAN 702 to a cell provided by the T-RAN 703. The decision to handover may be based on any of a plurality of different schemes. For example, the decision to handover may be based on a layer 3 (e.g., network layer) measurement report transmitted by the UE 701 and/or a layer 1 (e.g., physical layer) measurement report transmitted by the UE 701, and/or a network decision based on a current state of the RAN network(s) that are able to provide a service to the UE 701.

During 7004, the UE 701, S-RAN 702, and T-RAN 703 may prepare for handover. For example, this may apply in the case of conditional handovers, in which cells are prepared at a target RAN node and at the UE is provided with at least one condition that, when fulfilled, will cause the UE to initiate handover to one of the prepared cells.

During 7005, the UE is handed over from a cell provided by the S-RAN 702 to a cell provided by T-RAN 703. The T-RAN 504 may determine during 7005 that the T-RAN 504 does not support L4S-based ECN marking. The T-RAN 504 may further determine (e.g., from context shared from the S-RAN), that the S-RAN 503 supports L4S-based ECN marking.

During 7006, the T-RAN 703 signals the AMF 704. This signalling may comprise an indication that the T-RAN is unable to provide congestion marking to support L4S. This signalling may be provided in, for example, an N2 path switch request message.

From 7007, operations may be performed according to any of 5008 onwards and/or 6008 onwards, depending on the capabilities of the UPF 706.

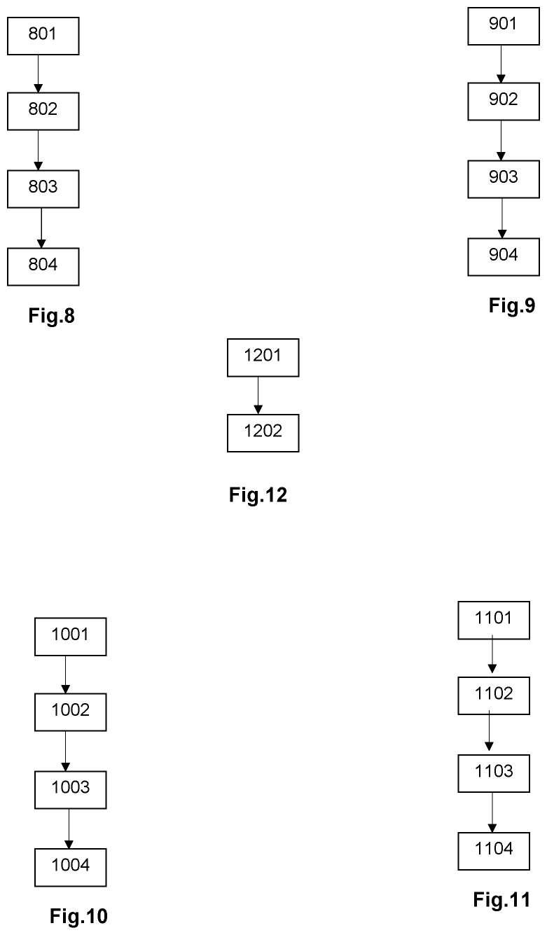

FIGS. 8 to 12 illustrate features of the above description. It is therefore understood that these features may find correspondence in the above description, which may be used to provide example implementations.

The example of FIG. 8 may relate to changing from above-mentioned congestion method 1 to above-mentioned congestion method 2 following handover of a UE from a source cell to a target cell.

FIG. 8 illustrates operations that may be performed by an apparatus, such as a network-based apparatus. The apparatus may comprise the functionality of a core network apparatus. The apparatus may comprise the functionality of a session management function.

During 801, the apparatus receives an indication that a user equipment will be or has been handed over from a first access network node to a second access network node, the first access network node being configured to provide a first congestion control mechanism.

During 802, the apparatus receives an indication that the second access network node does not support the first congestion control mechanism.

The indication that the second access network node does not support the first congestion control mechanism may be performed in any of a plurality of different ways.

For example, the indication that the second access network node does not support the first congestion control mechanism may be received from the second access network node. The indication that the second access network node does not support the first congestion control mechanism may be received via a session update request. The indication that the second access network node does not support the first congestion information may be received via another network entity.

During 803, the apparatus determines that a user plane function is able to perform a second congestion control mechanism. The user plane function may be a user plane function maintaining a session between the user equipment and an application function or application server via the first access network node. The user plane function may be some other user plane function than the user plane function maintaining a session between the user equipment and an application function or application server via the first access network node.

During 804, the apparatus signals the user plane function a request to perform the second congestion control mechanism for at least one packet signalled between the user equipment and the second access network node.

It is understood that the first and second congestion control mechanism may comprise different actions.

It is understood that the first and second congestion control mechanism may comprise the same or similar actions, while being performed by different apparatuses (e.g., a radio access node and a user plane function respectively). For example, both of these mechanisms may comprise performing ECN marking of packets that are provided to a user equipment (or to perform some pre-agreed explicit marking of a packet to indicate that that packet is being transmitted in a congested network environment). A primary distinction between the first and second congestion control mechanisms may relate to a way in which the apparatus performing their respective mechanism obtains information regarding which packet(s) to mark as congested. For example, for the first congestion control mechanism, the entity performing the marking may directly identify the congestion itself and mark packet(s) accordingly. In contrast, for the second congestion control mechanism, the entity performing the marking may receive an indication of the congestion for a packet from another entity (e.g., the user plane function may receive an indication of the congestion from the second access network node, and use this received information to mark packet(s)).

Packets that have been marked may subsequently be transmitted downlink to the user equipment (e.g., in the congested network environment).

The apparatus may signal an instruction to the second access network node to provide congestion information on said at least one packet to the user plane function that indicates whether the at least one packet experienced congestion (e.g., whether the at least one packet was or will be transmitted and/or received in a congested radio environment).

The determining that the user plane function is able to perform the first congestion control mechanism may comprise receiving an indication from the user plane function that the user plane function is able to perform the first congestion control mechanism. The determining that the user plane function is able to perform the first congestion control mechanism may comprise obtaining an indication from a network repository function that the user plane function is able to perform the first congestion control mechanism.

The apparatus may maintain session information for a session between an application function or application server and the user equipment via the first access network node prior to the user equipment being handed over from the first access network node, and/or maintain session information for a session between the application function or application server and the user equipment via the second access network node subsequent to the user equipment being handed over to the second access network node.

The apparatus of FIG. 8 may implement a virtual network function instance of a session management function.

The example of FIG. 9 may relate to changing from above-mentioned congestion method 1 to above-mentioned congestion method 3 following handover of a UE from a source cell to a target cell.

FIG. 9 illustrates operations that may be performed by an apparatus, such as a network-based apparatus. The apparatus may comprise the functionality of a core network apparatus. The apparatus may comprise the functionality of a session management function.

During 901, the apparatus receives an indication that a user equipment will be or has been handed over from a first access network node to a second access network node, the first access network node being configured to provide a first congestion control mechanism.

During 902, the apparatus receives an indication that the second access network node does not support the first congestion control mechanism.

The indication that the second access network node does not support the first congestion control mechanism may be performed in any of a plurality of different ways.

For example, the indication that the second access network node does not support the first congestion control mechanism may be received from the second access network node. The indication that the second access network node does not support the first congestion control mechanism may be received via a session update request. The indication that the second access network node does not support the first congestion information may be received via another network entity.

During 903, the apparatus determines that a second access network node is able to perform a third congestion control mechanism.

During 904, the apparatus signals, to the second access network node, an instruction to perform the third congestion control mechanism for at least one packet signalled between the second access network node and the user equipment.

It is understood that the first and third congestion control mechanism may comprise different actions.

For example, the first congestion control mechanism may relate to an access network node that detects congestion in a network and uses this detection to explicitly mark packet(s) being transmitted in that network as being congested. In contrast, the third congestion control mechanism may relate to an access network node that provides information on whether packet(s) are being transmitted in a congested network to another entity (e.g., an application function and/or application server using user plane and/or control plane signalling). The third congestion control mechanism may not comprise any explicit marking of packets by the access network node performing the third congestion control mechanism.

The apparatus may determine that a user plane function is unable to perform a second congestion control mechanism.

It is understood that the first and second congestion control mechanism may comprise different actions.

It is understood that the first and second congestion control mechanism may comprise the same or similar actions, while being performed by different apparatuses (e.g., a radio access node and a user plane function respectively). For example, both of these mechanisms may comprise performing ECN marking of packets that are provided to a user equipment (or to perform some pre-agreed explicit marking of a packet to indicate that that packet is being transmitted in a congested network environment). A primary distinction between the first and second congestion control mechanisms may relate to a way in which the apparatus performing their respective mechanism obtains information regarding which packet(s) to mark as congested. For example, for the first congestion control mechanism, the entity performing the marking may directly identify the congestion itself and mark packet(s) accordingly. In contrast, for the second congestion control mechanism, the entity performing the marking may receive an indication of the congestion for a packet from another entity (e.g., the user plane function may receive an indication of the congestion from the second access network node, and use this received information to mark packet(s)).

Packets that have been marked may subsequently be transmitted downlink to the user equipment (e.g., in the congested network environment).

The apparatus may maintain session information for a session between an application function or application server and the user equipment via the first access network node prior to the user equipment being handed over from the first access network node, and/or maintain session information for a session between the application function or application server and the user equipment via the second access network node subsequent to the user equipment being handed over to the second access network node.

The apparatus of FIG. 9 may implement a virtual network function instance of a session management function.

The example of FIG. 10 may relate to changing from above-mentioned congestion method 1 to above-mentioned congestion method 2 following handover of a UE from a source cell to a target cell.

FIG. 10 illustrates operations that may be performed by an apparatus. The apparatus may comprise the functionality of an access network node. For example, the apparatus may comprise the functionality of a first and/or second access network node. The second access network node may correspond to a second access network node as discussed above in relation to FIG. 8. The first access network node may correspond to a first access network node as discussed above in relation to FIG. 8.

During 1001, the apparatus determines that a user equipment will be or has been handed over from a first access network node to the apparatus.

During 1002, the apparatus determines that the apparatus does not support a first congestion control mechanism that is performed by the first access network node.

During 1003, the apparatus signals to a core network node an indication that the apparatus does not support the first congestion control mechanism.

This signalling of 1003 may be performed in response to a query signalled from a network node (e.g., an access and mobility function and/or from the core network apparatus). This signalling of 1003 may be performed autonomously in response to a handover being triggered at a radio access network-level (e.g., by an access network node and/or by a user equipment). Therefore the signalling of 1003 may be performed with or without receiving a request for this information from the core network apparatus.

During 1004, the apparatus receives, from the core network node, an instruction to provide congestion information to a user plane function for at least one packet signalled between the user equipment and the second access network node.

As mentioned above, the apparatus may perform functionality of a second access network node.

The apparatus may perform the functionality of the first access network node.

The indication that the second access network node does not support the first congestion control mechanism may be comprised in a handover request acknowledgement.

The indication that the second access network node does not support the first congestion control mechanism may be comprised in a path switch request.

The core network node may comprise the apparatus described above in relation to FIG. 8 (e.g., an apparatus comprising the functionality of a session management function).

It is understood that the first and second congestion control mechanism may comprise the same or similar actions, while being performed by different apparatuses (e.g., a radio access node and a user plane function respectively). For example, both of these mechanisms may comprise performing ECN marking of packets that are provided to a user equipment (or to perform some pre-agreed explicit marking of a packet to indicate that that packet is being transmitted in a congested network environment). A primary distinction between the first and second congestion control mechanisms may relate to a way in which the apparatus performing their respective mechanism obtains information regarding which packet(s) to mark as congested. For example, for the first congestion control mechanism, the entity performing the marking may directly identify the congestion itself and mark packet(s) accordingly. In contrast, for the second congestion control mechanism, the entity performing the marking may receive an indication of the congestion for a packet from another entity (e.g., the user plane function may receive an indication of the congestion from the second access network node, and use this received information to mark packet(s)).

Packets that have been marked may subsequently be transmitted downlink to the user equipment (e.g., in the congested network environment).

The example of FIG. 11 may relate to changing from above-mentioned congestion method 1 to above-mentioned congestion method 3 following handover of a UE from a source cell to a target cell.

FIG. 11 illustrates operations that may be performed by an apparatus. The apparatus may comprise the functionality of an access network node. For example, the apparatus may comprise the functionality of a first and/or second access network node. The second access network node may correspond to a second access network node as discussed above in relation to FIG. 9. The first access network node may correspond to a first access network node as discussed above in relation to FIG. 9.

During 1101, the apparatus determining that a user equipment will be or has been handed over from a first access network node to the apparatus.

During 1102, the apparatus determines that the access network node does not support a first congestion control mechanism that is performed by the first access network node.

During 1103, the apparatus signals to a core network apparatus an indication that the apparatus does not support the first congestion control mechanism.

This signalling of 1103 may be performed in response to a query signalled from a network node (e.g., an access and mobility function and/or from the core network apparatus). This signalling of 1103 may be performed autonomously in response to a handover being triggered at a radio access network-level (e.g., by an access network node and/or by a user equipment). Therefore, the signalling of 1103 may be performed with or without receiving a request for this information from the core network apparatus.

During 1104, the apparatus receives, from the core network apparatus, an instruction to provide congestion information to an application function or application server for at least one packet signalled between the user equipment and the second access network node.

The apparatus may explicitly send the congestion information to the application function or application server by using user plane and/or control plane signalling As mentioned above, the apparatus may perform functionality of a second access network node.

The apparatus may perform the functionality of the first access network node.

The indication that the second access network node does not support the first congestion control mechanism may be comprised in a handover request acknowledgement.

The indication that the second access network node does not support the first congestion control mechanism may be comprised in a path switch request.

FIG. 12 illustrates that may be performed by an apparatus. For example, the apparatus may be implemented as a first access network node, and/or perform functions of a first access network node. The first access network node may be the first access network node described above in relation to any of FIGS. 8 to 11.

During 1201, the apparatus determines that a user equipment will be or has been handed over from a first cell provided by the first access network node to a second cell provided by a second access network node.

During 1202, the apparatus provides, to the second access network node, an indication that the first access network node supports a first congestion control mechanism that is provided by the first access network node. This indication may be provided in response to the first access network node performing the determining of 1201.

In all of the above examples of FIGS. 8 to 12, the first congestion control mechanism may comprise an access network node explicitly marking packets as congested when there is determined to be congestion between a cell provided by the access network node and the user equipment. The first congestion control mechanism may comprise an ECN-based mechanism. For example, the first congestion control information may comprise a low latency low loss and scalable throughput congestion control mechanism.

The foregoing description has provided by way of non-limiting examples a full and informative description of some examples. However, various modifications and adaptations may become apparent to those skilled in the relevant arts in view of the foregoing description, when read in conjunction with the accompanying drawings and the claims. However, all such and similar modifications of the teachings will still fall within the scope of the examples described herein.

For instance, although the above examples are provided in the context of inter-DU cell switches, analogous signalling may be performed for inter-CU cell switching.

Further, in one approach, L4S traffic can be rerouted through a different path that supports L4S or making handover decision based on a target RAN L4S support information. In such cases, the network access network node may signal its capabilities to the network, and the network should take appropriate measures to ensure that the node does not cause congestion in the network.

In another approach, instead of the congestion marking being transferred to another network node, a target network node may be configured to use a different congestion control mechanism that is supported by the target network node.

In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

As provided herein, various examples are described in the detailed description. In general, some examples may be implemented in hardware or special purpose circuits, software code, logic or any combination thereof. For example, some examples may be implemented in hardware, while other examples may be implemented in firmware or software code which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software code, firmware code, special purpose circuits or logic, general purpose hardware or controller or other computing devices, or some combination thereof.

The examples may, for instance, be implemented by instructions (e.g., program instructions of computer software code) stored in a memory and executable by at least one data processor of the involved entities or by hardware, or by a combination of software code and hardware.

The memory referred to herein may be of any type suitable to the local technical environment and may be implemented using any suitable data storage technology, such as semiconductor based memory devices, magnetic memory devices and systems, optical memory devices and systems, fixed memory and removable memory.

The (data) processors referred to herein may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Further in this regard it should be noted that any procedures, e.g., as in FIG. 8, and/or FIG. 9, and/or FIGG. 10, and/or FIG. 11 and/or FIG. 12, and/or otherwise described previously, may represent operations of a computer program being deployed by at least one processor comprised in an apparatus (where a computer program comprises instructions for causing an apparatus to perform at least one action, the instructions being represented as software code stored on at least one memory), or interconnected logic circuits, blocks and functions, or a combination of operations of a computer program being deployed by at least one processor comprised in an apparatus and logic circuits, blocks and functions. The software code may be stored on memory, such as physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used herein, the term “circuitry” or “means” may refer to one or more or all of the following:
(a) hardware-only circuit implementations (such as implementations in only analogue and/or digital circuitry);
(b) combinations of hardware circuits and software cade, such as:
   (i) a combination of analogue and/or digital hardware circuit(s) with software/firmware code and
   (ii) any portions of hardware processor(s) with software code (including digital signal processor(s)), software code, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software code (e.g., firmware) for operation, but the software code may not be present when it is not needed for operation.

This definition of circuitry applies to all uses of this term herein, including in any claims. As a further example, as used in this application, the term circuitry also covers an implementation of merely a hardware circuit or processor (or multiple processors) or portion of a hardware circuit or processor and its (or their) accompanying software and/or firmware code. The term circuitry also covers, for example integrated device.

Implementations of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “non-transitory,” as used herein, is a limitation of the medium itself (i.e., tangible, not a signal) as opposed to a limitation on data storage persistency (e.g., RAM vs. ROM).

The scope of protection sought for various examples of the disclosure is set out by the independent claims. The examples and features, if any, described in this specification that do not fall under the scope of the independent claims are to be interpreted as examples useful for understanding the disclosure.

The foregoing description has provided by way of non-limiting examples a full and informative description of example implementations of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of examples described herein. Indeed, there is a further implementation comprising a combination of one or more examples with any of the other examples previously discussed.

The following provides examples of how the above described principle may be reflected in 3GPP, with the underlined portions corresponding to examples of the above. These sections may correspond to Sections currently comprised in 3GPP TS 23.501.

### 5.37.3.1 General

L4S (Low Latency, Low Loss and Scalable Throughput) is described in IETF RFC 9330[159 ], IETF RFC 9331 [160] and IETF RFC 9332[161]. It exposes congestion information by marking ECN bits in the IP header of the user IP packets between the UE and the application server to trigger application layer rate adaptation.
In 5G System, ECN marking for L4S may be supported. ECN marking for L4S is enabled on a per QOS Flow basis in the uplink and/or downlink direction and may be used for GBR and non-GBR QOS Flows. ECN marking for the L4S in the IP header is supported in either the NG-RAN (see clause 5.37.3.2 and TS 38.300[27]), or in the PSA UPF (see clause 5.37.3.3).
NOTE 1: Whether NG-RAN or PSA UPF based ECN marking for L4S is used is decided by SMF based on operator's network configuration and policies.
In the case of ECN marking for L4S by UPF, the NG-RAN is instructed to perform congestion information monitoring.
NOTE 2: As for any QoS flow, QOS rules in the UE and PDRs in the PSA UPF control which packets are bound to the L4S enabled QoS flow. The Packet Filter Set in the QoS rule or PDR can use packet filter(s) in clause 5.7.6.2 (e.g. ECT(1) and/or IP 5 tuple) to steer traffic to an L4S enabled QoS Flow.
NOTE 3: A QOS flow may be enabled with ECN marking for L4S requirement e.g. statically when a PDU session is established based on configuration in SMF or PCF, or dynamically based on detection of the L4S traffic e.g. via ECT(1) and/or IP 5 tuple in the IP header whereby SMF or PCF triggers a setup of a QOS Flow enabled for L4S, or by requests by an AF.
NOTE 4: To support this functionality, the UE may support L4S feedback as described in IETF RFC 9330[159 ], which is not in the scope of 3GPP.
NOTE X: During UE mobility, e.g., NG-RAN Handover or local PSA UPF relocation, SMF/PCF may decide how the congestion methods are to be managed in 5GC when the target NG-RAN and/or PSA UPF not capable of L4S.

### 5.37.3.2 Support of ECN Marking for L4S in NG-RAN

ECN marking for L4S may be supported in NG-RAN as specified in TS 38.300[27].

To enable support of ECN marking for L4S in NG-RAN, dedicated QoS Flow(s) are used for carrying L4S enabled IP traffic. The SMF may be configured to, based on PCC Rule provide an indication for ECN marking for L4S to NG-RAN for a corresponding QoS Flow(s), but in the absence of such configuration the use of L4S on a QoS flow is controlled by a coordinated configuration in NG-RAN and 5GC.

In case of handover or roaming of the UE, if the target NG-RAN does not support L4S, then SMF may switch to ECN marking for L4S in PSA UPF as defined in 5.37.3.3 [N.B. the second congestion control mechanism]. If the PSA UPF also is not supporting L4S, then SMF may enable the network exposure for congestion information as defined in 5.37.4. [N.B. the third congestion control mechanism]
The criteria based on which NG-RAN decides to mark ECN bits for L4S is NG-RAN implementation specific.

### 5.37.3.3 Support of ECN Marking for L4S in PSA UPF

To enable ECN marking for L4S by a PSA UPF, a QoS Flow level ECN marking for L4S indicator may be sent by SMF to PSA UPF over N4. SMF also indicates to NG-RAN to report the congestion information (i.e. a percentage of packets that UPF uses for ECN marking for L4S) of the QoS Flow on UL and/or DL directions via GTP-U header extension to PSA UPF. If there is no UL packet when report for DL and/or UL needs to be provided, NG-RAN may generate an UL Dummy GTP-U Packet for such a reporting.
Upon successful activation of congestion information reporting for UL and/or DL, PSA UPF uses information sent by NG-RAN in GTP-U header extension (see TS 38.415[116] and TS 38.300[27 ]) to perform ECN bits marking for L4S for the corresponding direction.
In case of roaming of the UE, if the target UPF does not support L4S, then the SMF may switch to ECN marking or L4S in target NG-RAN by following 5.37.3.2. [N.B. the first congestion control mechanism]. If the target NG-RAN also is not supporting L4S, then SMF may enable the network exposure for congestion information as defined in 5.37.4. [N.B. the third congestion control mechanism]

### 5.8.2.7 PDU Session and QoS Flow Policing

ARP is used for admission control (i.e. retention and pre-emption of the new QoS Flow).
The value of ARP is not required to be provided to the UPF.
For every QOS Flow, the SMF may determine the transport level packet marking value (e.g. the DSCP in the outer IP header) based on the 5QI, the Priority Level (if explicitly signalled) and optionally, the ARP priority level and provide the transport level packet marking value to the UPF.
The SMF may provide the Session-AMBR values of the PDU Session to the UPF so that the UPF can enforce the Session-AMBR of the PDU Session across all Non-GBR QoS Flows of the PDU Session.
SMF may provide the GFBR and MFBR value for each GBR QOS Flow of the PDU Session to the UPF. SMF may also provide the Averaging window to the UPF, if Averaging window is not configured at the UPF or if it is different from the default value configured at the UPF.
SMF may decide to activate ECN marking for L4S by PSA UPF for the QoS Flow (see clause 5.37). In this case, the SMF may send an ECN marking for L4S indicator to UPF. If PSA UPF does not have L4S support, then SMF may enable either ECN marking for L4S by NG-RAN (as per 5.37.3.2) or enable the network exposure for congestion information as defined in 5.37.4. [N.B. the first congestion control mechanism, and the third congestion control mechanism, respectively.]

1-36. (canceled)

37. An apparatus comprising
at least one processor, and
at least one memory storing instructions that, when executed by the at least one processor, cause the apparatus at least to perform:
receiving an indication that a user equipment will be or has been handed over from a first access network node to a second access network node, the first access network node being configured to provide a first congestion control mechanism;
receiving an indication that the second access network node does not support the first congestion control mechanism;
determining that a user plane function is able to perform a second congestion control mechanism; and
signalling the user plane function a request to perform the second congestion control mechanism for at least one packet signalled between the user equipment and the second access network node.

38. The apparatus as claimed in claim 37,
wherein the instructions, when executed by the at least one processor, cause the apparatus at least to perform:
signalling an instruction to the second access network node to provide congestion information on said at least one packet to the user plane function that indicates whether the at least one packet experienced congestion.

39. The apparatus as claimed in claim 37,
wherein the determining that the user plane function is able to perform the second congestion control mechanism comprises:
receiving an indication from the user plane function that the user plane function is able to perform the second congestion control mechanism.

40. The apparatus as claimed in claim 37,
wherein the first and second congestion control mechanisms both comprise marking the at least one packet as congested.

41. The apparatus as claimed in claim 37,
wherein the instructions, when executed by the at least one processor, cause the apparatus at least to perform:
functions of a core network function.

42. The apparatus as claimed in claim 41,
wherein the core network function is a session management function.

43. An apparatus comprising
at least one processor, and
at least one memory storing instructions that, when executed by the at least one processor, cause the apparatus at least to perform:
determining that a user equipment will be or has been handed over from a first access network node to the apparatus;
determining that the apparatus does not support a first congestion control mechanism that is performed by the first access network node;
signalling to a core network node an indication that the apparatus does not support the first congestion control mechanism; and
receiving, from the core network node, an instruction to provide congestion information to a user plane function for at least one packet signalled between the user equipment and the apparatus.

44. The apparatus as claimed in claim 43,
wherein the instructions, when executed by the at least one processor, cause the apparatus at least to perform:
functions of a second access network node.

45. The apparatus as claimed in claim 43,
wherein the apparatus is implemented as the second access network node.

46. The apparatus as claimed in claim 43,
wherein the indication that the apparatus does not support the first congestion control mechanism is comprised in a handover request acknowledgement.

47. The apparatus as claimed in claim 43,
wherein the indication that the second access network node does not support the first congestion control mechanism is comprised in a path switch request.

48. An apparatus comprising
at least one processor, and
at least one memory storing instructions that, when executed by the at least one processor, cause the apparatus at least to perform:
determining that a user equipment will be or has been handed over from a first cell provided by a first access network node to a second cell provided by a second access network node; and
providing, to the second access network node, an indication that the first access network node supports a first congestion control mechanism that is provided by the first access network node.

49. The apparatus as claimed in claim 48,
wherein the instructions, when executed by the at least one processor, cause the apparatus at least to perform:
functions of the first access network node.

50. The apparatus as claimed in claim 48,
wherein the apparatus is implemented as the first access network node.

51. The apparatus as claimed in claim 48,
wherein the first congestion control mechanism comprises an access network node explicitly marking packets as congested when there is determined to be congestion between a cell provided by the access network node and the user equipment.

52. The apparatus as claimed in claim 51,
wherein a second congestion control mechanism comprises a user plane function explicitly marking packets as congested when there is determined to be congestion between the cell provided by the access network node and the user equipment.

53. An apparatus as claimed in claim 52,
wherein the first congestion control mechanism or the second congestion control mechanism comprises a low latency low loss and scalable throughput congestion control mechanism.
